(19) United States
(12) Patent Application Publication
(10) Pub. No.: US 2021/0122620 A1
(43) Pub. Date: Apr. 29, 2021

(54) Method for Controlling a Working Platform, Control Device, and Inclination Angle Measuring System for a Working Platform

(71) Applicant: Robert Bosch GmbH, Stuttgart (DE)

(72) Inventors: Udo Schulz, Vaihingen/Enz (DE); Thomas Thiel, Eberdingen (DE); Filip Rosenstein, Stuttgart (DE)

(21) Appl. No.: 16/618,989

(22) PCT Filed: May 25, 2018
(86) PCT No.: PCT/EP2018/063834

§ 371 Date: Dec. 3, 2019

(30) Foreign Application Priority Data
Jun. 8, 2017 (DE) 10 2017 209 695.0

(51) Int. Cl. B66F 9/24; B66F 9/075; G01B 11/02

(52) U.S. Cl. CPC B66F 9/24; G01B 11/026; B66F 9/0755

(57) ABSTRACT

A method controls a working platform having at least one distance sensor assigned to a wheel of the working platform. A time of flight of a measuring beam, which represents a beam emitted obliquely onto a track of the working platform by the distance sensor, is determined. The time of flight determined in this manner is compared with a reference time of flight in order to determine a change in the inclination angle of the working platform. A control signal for controlling the working platform is output on the basis of the inclination angle change. As a result, a change in the gradient of a track in front of each wheel is individually determined before the particular wheel travels on the track section with the inclination change.

### PRIOR ART

The invention is directed to a device or a method according to the species of the independent claims. The subject matter of the present invention is also a computer program.

Inclination angle measuring systems for lifting working platforms are known.

Against this background, a method, a control device which uses this method, and a corresponding computer program as claimed in the main claims are provided by the approach provided here. Advantageous refinements and improvements of the device specified in the independent claim are possible by way of the measures set forth in the dependent claims.

A method for controlling a working platform is provided, wherein the working platform comprises at least one distance sensor associated with the wheel of the working platform, wherein the method comprises the following steps:

comparing a time of flight of a measurement beam, which is emitted obliquely by the distance sensor onto a track of the working platform and is reflected from the track, to a reference time of flight in order to ascertain an inclination angle change of the working platform; and

outputting a control signal to control the working platform in dependence on the inclination angle change.

A working platform can be understood as a movable lifting working platform. For example, the working platform can be constructed on a self-propelled chassis. The working platform can also be implemented as a truck superstructure, for example. A distance sensor can be understood, for example, as a laser, lidar, radar, or ultrasonic sensor or a camera. The distance sensor can be installed, for example, on the wheel, a wheel axle, or the chassis and can be aligned in such a way that the measurement beam is incident obliquely on the track. In this case, the measurement beam can comprise a directional component aligned parallel to the vertical axis and a directional component aligned parallel to the longitudinal axis or parallel to a present or future travel direction. A track can be understood as a section of a surface of a terrain traveled presently or foreseeably by the working platform. A time of flight can be understood as a time span between emitting and receiving the reflected measurement beam. In a step of ascertainment, the time of flight of the measurement beam can be ascertained. The reference time of flight can be a time of flight from a prior time of flight measurement by means of the distance sensor or a stored reference value. An inclination angle change can be understood as a difference between a present inclination angle and a foreseeable inclination angle of the working platform. Although reference is predominantly made to a working platform in the embodiments, the described approach can thus also be used in other vehicles or working devices.

If a working platform travels over uneven terrain, for example, over holes or waves or on routes having descents or ascents, depending on the displacement of the mass center of gravity of the working platform, tilting of the working platform can occur. In particular in the case of remote control of the propulsion of the working platform from a platform, the ground profile often cannot be properly seen by the operator.

The approach provided here is based on the finding that an inclination angle change of a working platform when driving on uneven underlying surface can be reliably predetermined by a time of flight measurement carried out individually by wheel. Tipping over of the working platform in arbitrary directions can be avoided, for example, by individually determining a slope change of a track in front of each wheel, for example, by means of laser distance meter, before the respective wheel travels the track section having the slope change. The slope change measured in the travel direction in front of each wheel or the change of the mass center of gravity of the working platform resulting therefrom can then be visualized for the operator, for example, or a corresponding warning message can be output to the operator. Alternatively or additionally, the working platform can be automatically braked or stopped. Damage to persons and property due to an inclining or tilting working platform can thus be prevented.

According to one embodiment, the method can comprise an additional step, in which the measurement beam is emitted having a directional component in a travel direction of the working platform. The measurement beam can thus be incident in a section of the track located in front of the wheel in the travel direction. The inclination angle change can thus be ascertained before the working platform travels the section on which the measurement beam is incident. Additionally or alternatively, the measurement beam can be emitted having a directional component opposite to the travel direction of the working platform. The travel direction can be a present or future travel direction or trajectory of the vehicle. In the step of emitting, the measurement beam can thus be emitted having a directional component along a trajectory of the working platform. It can thus be a directional component oriented on the trajectory. For this purpose, the trajectory and/or wheel track of the respective wheel which is known or predicted in accordance with the steering wheel position and/or wheel position can be brought into congruence with the point of incidence and/or the alignment of the associated measurement beam, for example, a laser beam. The known kinematics of the vehicle can be used for determining the trajectory. Alternatively, the kinematics can be computed using the vehicle parameters. If the distance sensor is fastened to the wheel, an emission direction of the distance sensor is automatically changed in the event of a steering movement of the wheel, so that the measurement beam is always aligned on a section of the track located in front of the wheel in the travel direction. Alternatively, the measurement beam can be emitted in the step of emitting having a directional component set using a steering angle setting of the wheel. For this purpose, the distance sensor can comprise a settable emission direction. This is advantageous if the distance sensor is arranged on a chassis of the working platform.

According to one embodiment, in the step of comparing, an inclination angle change representing a descent can be ascertained if the time of flight is greater than the reference time of flight. Additionally or alternatively, an inclination angle representing an ascent can be ascertained if the time of flight is less than the reference time of flight. The inclination angle change can thus be reliably ascertained with low processing effort.

It is advantageous if, in the step of comparing, the inclination angle change is ascertained using a present inclination angle of the working platform or, additionally or alternatively, a permissible inclination angle of the working platform. A permissible inclination angle can be understood as a maximum inclination angle, at which the working platform is still just tilt stable. Tipping over of the working platform can thus be reliably prevented.

Furthermore, in the step of comparing, the inclination angle change can be ascertained using at least one wheel dimension value representing a dimension of the wheel or, additionally or alternatively, an inclination profile of the track provided by means of a digital map. A wheel dimension value can be understood, for example, as a radius, a diameter, a circumference, a width, or also a pressure of the wheel. A digital map can be understood, for example, as a map based on GPS data. The accuracy of the method can be enhanced by this embodiment.

Furthermore, in the step of outputting, the control signal can be output to brake or stop the working platform or to output a warning message to an operator of the working platform. The working platform can thus be automatically controlled in dependence on the inclination angle change. Tipping over of the working platform can thus be prevented particularly reliably or at least the risk of tipping over can be pointed out in a timely manner.

According to a further embodiment, the working platform can comprise at least one further distance sensor associated with a further wheel of the working platform. In this case, in the step of comparing, a further time of flight of a further measurement beam emitted obliquely by the further distance sensor onto the track and reflected from the track can be compared to the reference time of flight to ascertain the inclination angle change. The accuracy in the ascertainment of the inclination angle change can be further enhanced by this embodiment. In this case, the wheels, with each of which a distance sensor is associated, can be associated with the same or different axles of the working platform. According to one embodiment, a distance sensor is associated with each of the wheels.

The working platform can comprise at least one second distance sensor associated with the wheel, wherein in the step of comparing, a second time of flight of a second measurement beam emitted obliquely by the second distance sensor onto the track opposite to the measurement beam and reflected from the track, is compared to a second reference time of flight to ascertain a second inclination angle change. For example, the inclination angle change ascertained using the measurement signal can represent a change upcoming in the case of a forward travel and the inclination angle change ascertained using the second measurement signal can represent a change of the inclination of the working platform upcoming in the case of a reverse travel. The section of the track located in front of the wheel in the travel direction can thus be monitored independently of the travel direction.

This method can be implemented, for example, in software or hardware or in a mixed form of software and hardware, for example, in a control device.

The approach provided here furthermore provides a control device, which is designed to carry out, control, and/or implement the steps of a variant of a method provided here in corresponding units. The object on which the invention is based can also be achieved rapidly and efficiently by this embodiment variant of the invention in the form of a control device.

For this purpose, the control device can comprise at least one processing unit for processing signals or data, at least one storage unit for storing signals or data, at least one interface to a sensor or an actuator for inputting sensor signals from the sensor or for outputting control signals to the actuator, and/or at least one communication interface for inputting or outputting data which are embedded in a communication protocol. The processing unit can be, for example, a signal processor, a microcontroller, or the like, wherein the storage unit can be a flash memory, an EPROM, or a magnetic storage unit. The communication interface can be designed to input or output data in a wireless and/or wired manner, wherein a communication interface which can input or output data in a wired manner can input these data from a corresponding data transmission line or can output these data into a corresponding data transmission line, for example, electrically or optically.

A control device can be understood in the present case as an electrical device which processes sensor signals and outputs control and/or data signals in dependence thereon. The control device can comprise an interface which can be designed in hardware and/or software. In the case of a hardware design, the interfaces can be, for example, part of a so-called system ASIC, which contains greatly varying functions of the control device. However, it is also possible that the interfaces are separate integrated circuits or at least partially consist of discrete components. In the case of a software design, the interfaces can be software modules which are provided, for example, on a microcontroller in addition to other software modules.

In one advantageous design, a control of the vehicle is performed by the control device. For this purpose, the control device can access, for example, sensor signals such as acceleration, pressure, steering angle, or surroundings sensor signals. The activation takes place via actuators such as braking or steering actuators or a motor control device of the vehicle.

The approach provided here moreover provides an inclination angle measuring system for a working platform, wherein the inclination angle measuring system comprises the following features:

at least one distance sensor associated with a wheel of the working platform for emitting a measurement beam obliquely to a track of the working platform; and

a control device according to the preceding embodiment.

According to one embodiment, the distance sensor can be designed to emit the measurement beam in a direction facing in the travel direction of the working platform. For example, the distance sensor can comprise a first sensor element facing in a first travel direction and a second sensor element facing in a second travel direction opposite to the first travel direction. A foreseeable inclination angle can thus be ascertained reliably and accurately during the movement of the working platform.

According to a further embodiment, the inclination angle measuring system can comprise at least one further distance sensor associated with a further wheel of the working platform for emitting a further measurement beam obliquely to the track. For example, the wheel and the further wheel can be associated with a common axle or different axles. The robustness of the inclination angle measuring system against measurement errors can be significantly increased by this embodiment.

A computer program product or computer program having program code which can be stored on a machine-readable carrier or storage medium such as a semiconductor memory, a hard drive memory, or an optical memory and is used to carry out, implement, and/or control the steps of the method according to one of the above-described embodiments, in particular if the program product or program is executed on a computer or a device, is also advantageous.

Exemplary embodiments of the invention are illustrated in the drawings and explained in greater detail in the following description. In the figures:

FIG. 1 shows a schematic illustration of a working platform having an inclination angle measuring system according to one exemplary embodiment;

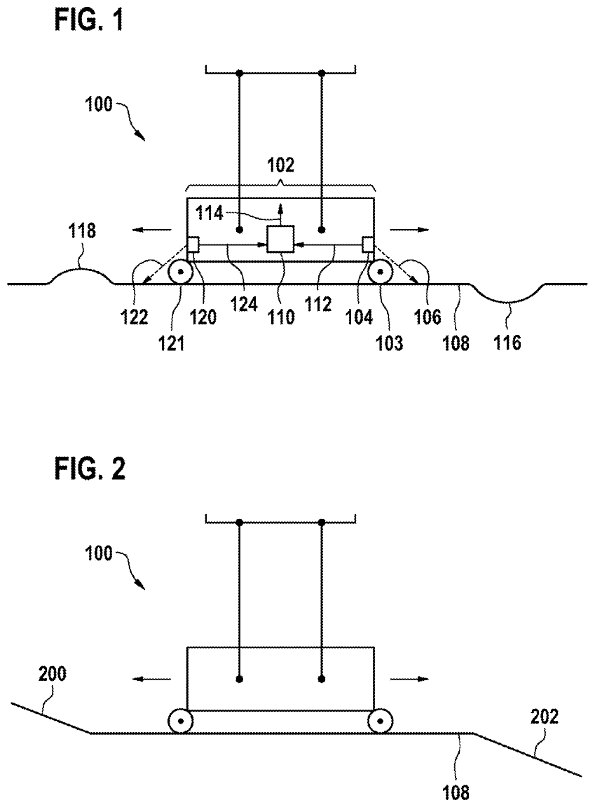

FIG. 2 shows a schematic illustration of a working platform from FIG. 1;

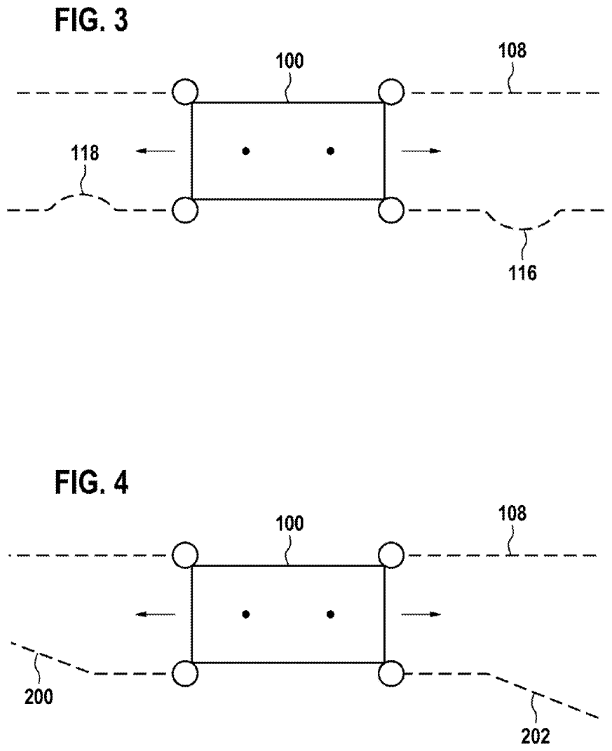

FIG. 3 shows a schematic illustration of a working platform from FIG. 1 in a top view;

FIG. 4 shows a schematic illustration of a working platform from FIG. 2 in a top view;

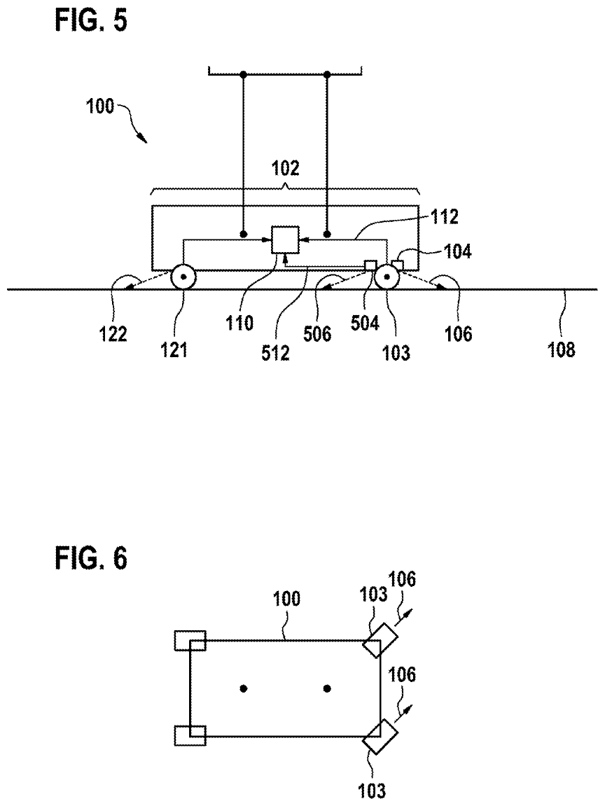

FIG. 5 shows a schematic illustration of a working platform having an inclination angle measuring system according to one exemplary embodiment;

FIG. 6 shows a schematic illustration of a working platform according to one exemplary embodiment in a top view;

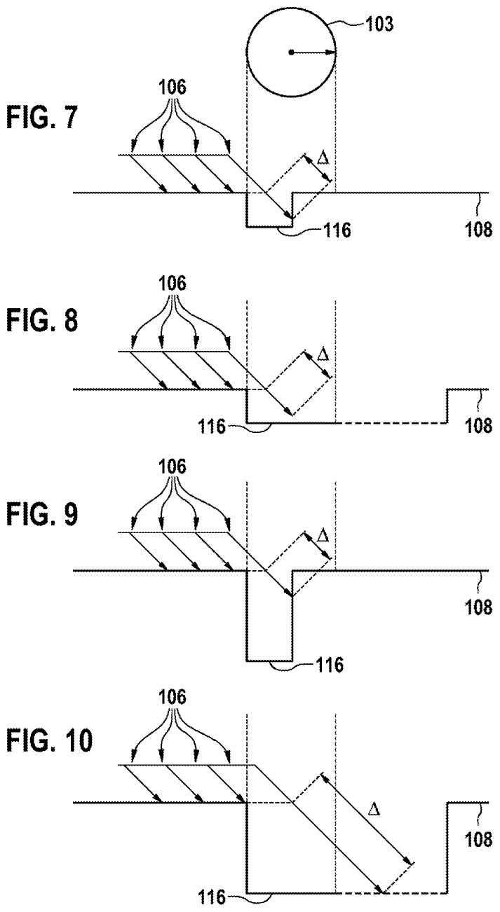

FIG. 7 shows a schematic illustration of a measurement beam profile during travel on an uneven track;

FIG. 8 shows a schematic illustration of a measurement beam profile during travel on an uneven track;

FIG. 9 shows a schematic illustration of a measurement beam profile during travel on an uneven track;

FIG. 10 shows a schematic illustration of a measurement beam profile during travel on an uneven track;

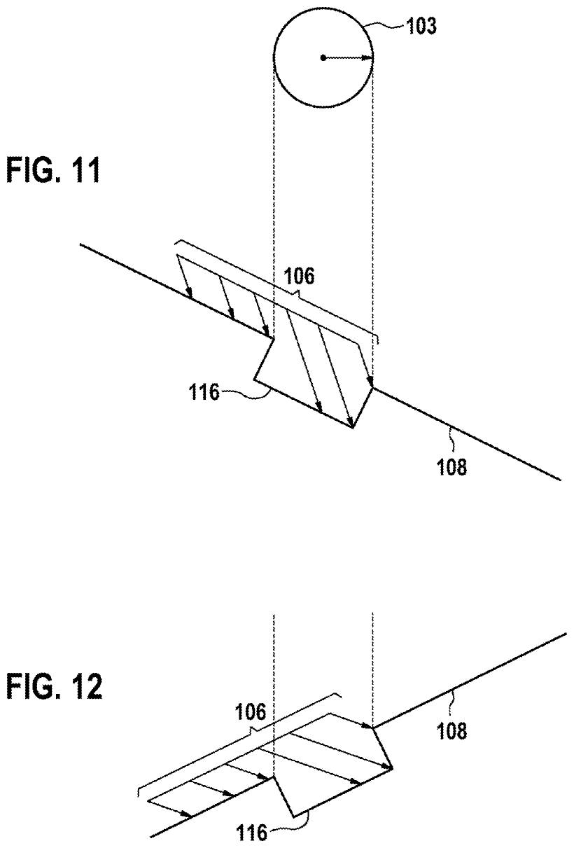

FIG. 11 shows a schematic illustration of a measurement beam profile during travel on an uneven descent;

FIG. 12 shows a schematic illustration of a measurement beam profile during travel on an uneven ascent;

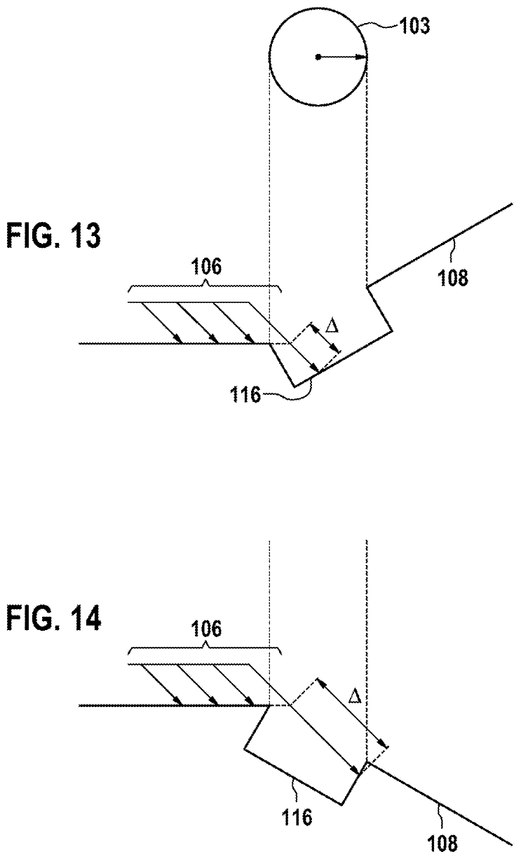

FIG. 13 shows a schematic illustration of a measurement beam profile during the transition into an uneven ascent;

FIG. 14 shows a schematic illustration of a measurement beam profile during the transition into an uneven descent;

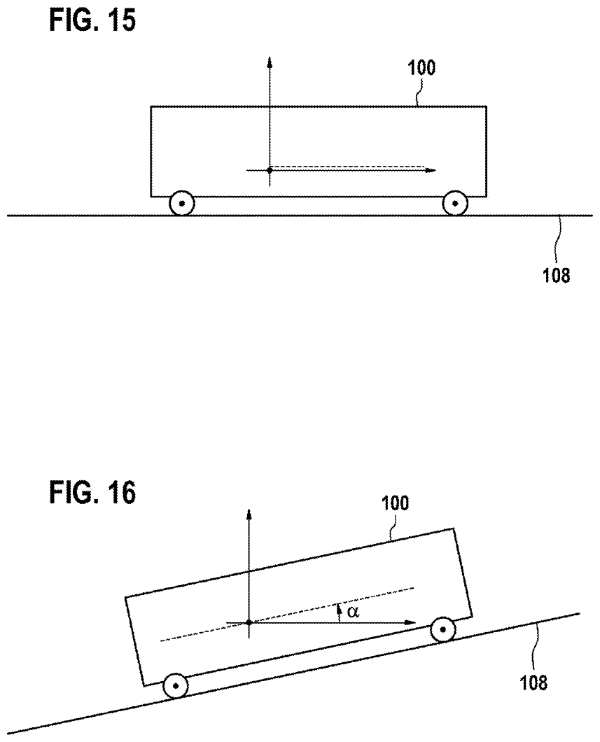

FIG. 15 shows a schematic illustration of an inclination angle of a working platform on level track;

FIG. 16 shows a schematic illustration of an inclination angle of a working platform on an ascent;

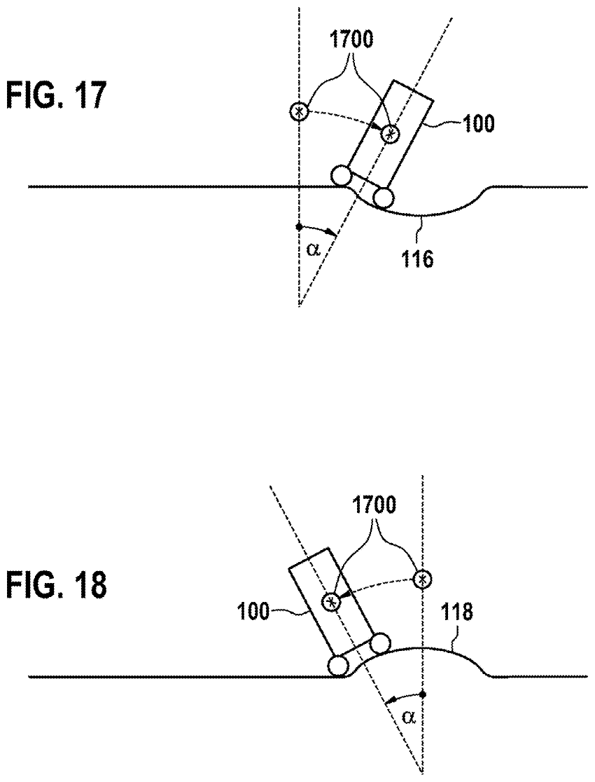

FIG. 17 shows a schematic illustration of a displacement of a mass center of gravity of a working platform in dependence on an inclination angle change during travel through a hole;

FIG. 18 shows a schematic illustration of a displacement of a mass center of gravity of a working platform in dependence on an inclination angle change during travel over a bump;

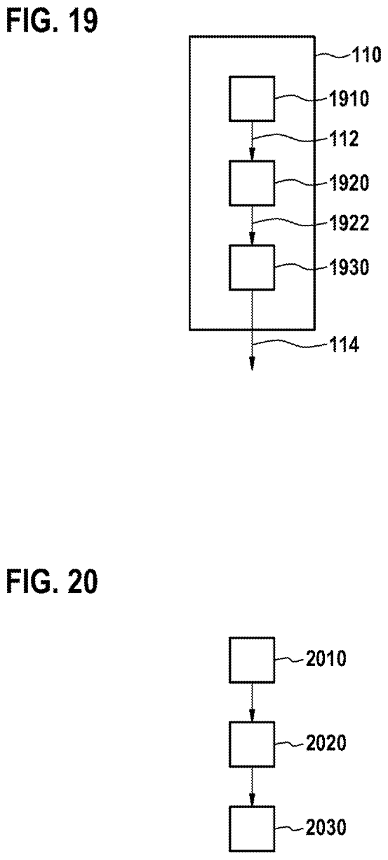

FIG. 19 shows a schematic illustration of a control device according to one exemplary embodiment; and

FIG. 20 shows a flow chart of a method according to one exemplary embodiment.

In the following description of advantageous exemplary embodiments of the present invention, identical or similar reference signs are used for the similarly-acting elements illustrated in the various figures, wherein a repeated description of these elements is omitted.

FIG. 1 shows a schematic illustration of a self-propelled movable working platform 100 having an inclination angle measuring system 102 according to one exemplary embodiment. The working platform 100 can in general be a vehicle which is provided for working use. The inclination angle measuring system 102 comprises a distance sensor 104, which is associated with a single wheel 103 of the working platform 100 and is designed to emit a measurement beam 106 onto a track 108 of the working platform 100, onto a section of the track 108 located in front of the wheel 103 in the travel direction here, and to receive it again after a reflection on the track 108. The track 108 represents in this case a travel plane of the working platform 100. Possible travel directions of the working platform 100 are each indicated by a horizontal arrow. A control device 110 of the inclination angle measuring system 102 is designed to receive a time of flight 112 from the distance sensor 104, which represents a time span between the emission of the measurement beam 106 and the reception of a reflected component of the measurement beam 106. In this case, the control device 110 compares the time of flight 112 of the measurement beam 106 to a reference time of flight, for example, a time of flight of a measurement beam emitted at an earlier point in time by the distance sensor 104, to ascertain an inclination angle change of the working platform 100 during travel on the track 108, more precisely an inclination angle which the working platform 100 will foreseeably have when it moves further in the travel direction on the track 108. The control device 110 generates a control signal 114 for controlling the working platform 100 in dependence on the ascertained inclination angle change and outputs it to corresponding actuators of the working platform 100, for example, a drive motor or a steering or braking actuator. By way of corresponding control of the working platform 100 by means of the control signal 114, for example, tipping over of the working platform 100 when traveling over irregularities, for example, over a hole 116 or a bump 118, can be counteracted in a timely manner.

According to the exemplary embodiment shown in FIG. 1, the inclination angle measuring system 102 is furthermore equipped with a further distance sensor 120, which is associated with a further single wheel 121 of the working platform 100. The further distance sensor 120 is designed similarly to the distance sensor 104, to emit a further measurement beam 122 onto a section of the track 108 located in front of the further wheel 121 and to transmit a further time of flight 124 to the control device 110. The further time of flight 124 represents in this case a time of flight of the further measurement beam 122. The control device 110 is accordingly designed to ascertain the inclination angle change of the working platform 100 with additional use of the further time of flight 124 and comparison of the further time of flight 124 to a further reference time of flight.

According to the exemplary embodiment shown, the distance sensors 104, 120 are associated with wheels 103, 121 of different axles of the working platform 100. In this case, the measurement beams 106, 122 can face in opposing directions or in the same direction. If the measurement beams 106, 122 face in the same direction, the respective rear wheel can monitor a section of the track 108 located in the travel direction in front of the rear wheel and the respective front wheel can monitor a section of the track 108 located in the travel direction in front of the front wheel. In this case, according to one exemplary embodiment, the emission direction of the measurement beams 106, 122 reverses when the travel direction reverses. The distance sensors 104, 120 can thus be designed to emit the measurement beams 106, 122 having a directional component dependent on the travel direction. In this way, the respective section of the track 108 located in the travel direction in front of the wheels 103, 121 can be monitored. According to an alternative exemplary embodiment, the distance sensors 104, 120 are associated with wheels of the same axle of the working platform 100. According to an alternative exemplary embodiment, a separate distance sensor 104, 120 is associated with each wheel 103, 121 of the working platform 100, so that the track 108 may be monitored very accurately.

As is apparent from FIG. 1, the two distance sensors 104, 120 are attached to the working platform 100 in such a way that the respective measurement beams 106, 122 are incident obliquely on the track or travel plane of the working platform 100 represented by the track 108. The measurement beams 106, 122 are thus emitted obliquely downward. The measurement beams 106, 122 can thus each be incident on a section of the track 108 located in front of the working platform 100, for example, on a section outside an imaginary footprint of the working platform 100 projected on a track surface, so that the inclination angle change can be ascertained before the present inclination angle of the working platform 100 actually changes.

Depending on the exemplary embodiment, the working platform 100 can also comprise more than two distance sensors 104, 120 for emitting measurement beams 106, 122.

Depending on the exemplary embodiment, the distance sensors 104, 120 are designed for optical distance measurement on the basis of a time of flight measurement, also called laser distance measurement, for phasing measurement, or for laser triangulation of light. Laser triangulation and laser interferometers are suitable in particular for short distances between several micrometers up to 100 m. Time of flight methods, in contrast, are more suitable for large distances between 1 and approximately 1000 m.

The working platform 100 stands stably on the horizontal track shown in FIG. 1 if the vertical projection of the center of gravity of the working platform 100 on the track 108 is within the footprint of the working platform 100. To tilt the working platform 100 around an edge, a torque is required which is greater than the opposing torque of gravity around the same axis.

The determination of the present inclination of the working platform 100 on the track 108 is performed, for example, by means of inclination sensors or three-axis acceleration sensors. The distance sensors 104, 120, such as laser distance meters, face with the respective measurement beam thereof in the direction of a future possible travel direction of the respective wheels. To detect irregularities of the track 108, for example, a corresponding distance sensor is installed on each wheel of the working platform 100.

The measurement beams 106, 122 are each directed onto the track 108 at such an angle that a future descent still permissible with respect to the tilt stability of the working platform 100 is detectable without the measurement beams 106, 122 going into empty space (however, the change is also detected here). An ascent is detected, for example, if the respective time of flight 112, 124 of the measurement beams 106, 122 decreases. Vice versa, a descent is detected if the respective time of flight 112, 124 of the measurement beams 106, 122 increases.

According to one exemplary embodiment, the control unit 110 ascertains a future inclination of the working platform 100 during the further travel from the distance measurement or time of flight measurement and the present inclination. The future inclination is graphically or numerically displayed, for example, on a display screen.

If the mass center of gravity of the working platform 100 is determined, for example, a permissible tilt-free inclination angle for the working platform 100 is determined and compared to the future inclination during further travel. If the future inclination exceeds the tilt-free inclination, a corresponding warning message is generated for the operator or the further travel of the working platform 100 is also stopped. The stopping procedure takes place sufficiently slowly in this case that the working platform 100 does not tilt as a result of the mass inertia, and sufficiently rapidly that the critical inclination is not reached. This also applies accordingly to the startup. The tilt inclination as a result of the required braking distance is also taken into consideration in the computation of the permissible future inclination. This also applies accordingly to the startup.

According to a further exemplary embodiment, the control device 110 determines a position-accurate inclination profile of the track 108 on the basis of GPS data with respect to already traveled paths and saves it in a dynamic map. The inclination profile can be read out via a suitable interface and thus made available to other vehicles or operators when traveling on the track 108. The corresponding inclination data are thus already provided to the operators before the inclination angle change is detected by the inclination angle measuring system 100. The operators can thus select a different travel path in a timely manner, for example.

Alternatively to laser distance meters, lidar, camera, radar, or ultrasonic systems or other distance measuring systems or combinations of different measuring systems are conceivable as distance sensors.

To reduce to a minimum the risk of tilting when traveling over irregularities or in the event of direction changes, for example, two distance sensors 104, 120 are attached to each wheel or wheel pair. In this case, the two distance sensors 104, 120 of a wheel or wheel pair each face in one of two possible travel directions of the working platform 100. Optionally, the distance sensors also move during steering. Therefore, it is ensured under all possible conditions that an area directly in front of the wheels is continuously monitored independently of the travel direction and thus tilting is precluded.

FIG. 2 shows a schematic illustration of a working platform 100 from FIG. 1. In contrast to FIG. 1, the track 108 is shown here having an ascent 200 and a descent 202.

FIG. 3 shows a schematic illustration of a working platform 100 from FIG. 1 in a top view. When traveling through the hole 116 or over the bump 118, the working platform 100 is lowered or raised, respectively, on one side. The inclination angle change of the working platform 100 accompanying this can be predictably ascertained by means of the inclination angle measuring system.

FIG. 4 shows a schematic illustration of a working platform 100 from FIG. 2 in a top view. Similarly as in FIG. 3, the working platform 100 can be brought out of balance in the event of a change of inclination on one side when traveling on the ascent 200 or the descent 202. This can also be prevented by timely detection of the inclination angle change by means of the inclination angle measuring system.

FIG. 5 shows a schematic illustration of a working platform 100 having an inclination angle measuring system 102 according to one exemplary embodiment. According to this exemplary embodiment, the distance sensors are each arranged adjacent to the wheels 103, 121. Similarly as in FIG. 1, the measurement beams 106, 122 are each incident obliquely on the track 108. In this case, the measurement beams 106, 122 face in opposing travel directions of the working platform 100.

According to one exemplary embodiment, a second distance sensor 504 is associated with at least one of the wheels 103, 121, the wheel 103 here, which emits a second measurement beam 506, which is aligned opposite to the measurement beam 106. Therefore, independently of the travel direction, one of the measurement beams 106, 506 is aligned obliquely downward in the travel direction and the other of the measurement beams 106, 506 is aligned obliquely downward opposite to the travel direction. According to this exemplary embodiment, a second time of flight 512 of the second measurement beam 506 is compared to a second reference time of flight to ascertain a second inclination angle change which is then relevant if the working platform 100 moves in the direction of the second measurement beam 506.

FIG. 6 shows a schematic illustration of a working platform 100 according to one exemplary embodiment in a top view, for example, the working platform described above on the basis of FIGS. 1 to 5. Cornering of the working platform 100 with turned wheels 103 is shown. A distance sensor, which is designed to follow the steering movement of the working platform 100, is associated with each of the turned wheels 103, as can be seen from the direction of the measurement beams 106 indicated by arrows.

According to one exemplary embodiment, directional components of the measurement beams 106 are set in this case using the steering angle settings of the wheels 103. The respective steering angle setting of a wheel 103 can be provided in this case, for example, by steering angle sensor coupled to the wheel 103 or a steering unit of the working platform 100.

The alignment of a measurement beam 106 can be different from the wheel alignment of the associated wheel 103. As a result, the alignment of, for example, laser and wheel 103 are not congruent during cornering, similarly to the intelligent cornering light. This results from the fact that according to one exemplary embodiment, the predicted trajectory of the working platform 100 or the predicted trajectory of a wheel 103 is brought into correspondence with the point of incidence and/or the alignment of the measurement beam 106. The measurement beam 106 can thus be aligned to the trajectory of the working platform 100. The predicted trajectory can be predetermined, provided by a control unit of the working platform 100, or determined, for example, using the kinematics of the working platform 100 and the steering angle.

FIG. 7 shows a schematic illustration of a measurement beam profile when traveling on an uneven track 108. The measurement beam profile represents, for example, a profile of the measurement beam 106 as the working platform shown in FIG. 1 approaches the hole 116. If the measurement beam 106 is incident in the hole 116, the width and depth of which is less here than a diameter of the wheel 103, its time of flight thus lengthens by the value Δ. The diameter of the wheel 103 or also a wheel dimension value representing another arbitrary wheel dimension of the wheel 103 is taken into consideration accordingly, for example, by the control device of the inclination angle measuring system when ascertaining the inclination angle change.

FIG. 8 shows the measurement beam profile from FIG. 7 for the case in which the width of the hole 116 is greater than or equal to and the depth is less than the diameter of the wheel 103.

FIG. 9 shows the measurement beam profile from FIG. 7 for the case in which the width of the hole 116 is less and the depth of the hole 116 is less than the diameter of the wheel 103. By means of the hole width and the hole depth and the knowledge of the wheel dimension values, it can (quasi-) be computed whether the wheel 103 travels completely into the hole 116. A computation of the secant can also be carried out if the wheel 103 only partially plunges into the hole 106, because the hole width is smaller in the wheel travel direction than the wheel diameter. The vehicle inclination can again be determined therefrom.

FIG. 10 shows the measurement beam profile for FIG. 7 for the case in which the width and depth of the hole 116 are greater than or equal to the diameter of the wheel 103.

FIGS. 11 and 12 each show the measurement beam profile of the measurement beam 106 when traveling on the track 108 provided with the hole 116, if it is inclined, wherein the track 108 represents a descent in FIG. 11 and represents an ascent in FIG. 12.

FIG. 13 shows a schematic illustration of a measurement beam profile during the transition from a level into a rising track 108. For example, the hole 116 is located here at the transition. Such an inclination change can also be reliably ascertained by means of the inclination angle measuring system in dependence on the time of flight change of the measurement beam 106 upon incidence in the hole 116 and also using a preceding time of flight of the measurement beam 106 when traveling on level track as a reference time of flight.

FIG. 14 shows a schematic illustration of a measurement beam profile of the measurement beam 106 upon the transition of the track 108 into a descent.

FIG. 15 shows a schematic illustration of an inclination angle of a working platform 100 on level track 108. The present inclination angle of the working platform 100 is 0° here.

FIG. 16 shows a schematic illustration of an inclination angle of a working platform 100 on an ascent. The ascent-dependent inclination angle is marked by the letter α.

FIG. 17 shows a schematic illustration of a displacement of a mass center of gravity 1700 of a working platform 100 in dependence on an inclination angle change during the travel through a hole 116.

FIG. 18 shows a schematic illustration of a displacement of a mass center of gravity 1700 of a working platform 100 in dependence on an inclination angle change during the travel over a bump 118.

FIG. 19 shows a schematic illustration of a control device 110 according to one exemplary embodiment. The control device 110 can be a control device described above on the basis of FIGS. 1 to 18. The control device 110 comprises an ascertainment unit 1910 for ascertaining the time of flight 112 using time values indicating an emission and a reception of the measurement beam by the distance sensor. The ascertainment unit 1910 relays a signal representing the time of flight 112 to a comparison unit 1920, which is designed to compare the time of flight 112 to the reference time and thus to ascertain the inclination angle change of the working platform. Such a “comparison” can be based according to the approach provided here on the measurement beam, for example, a laser beam, resulting in distance information scanned over the predicted trajectory. Together with the present vehicle inclination, the inclination profile or “height change profile” may be determined over the predicted trajectory.

The reference time of flight is stored, for example, in the comparison unit 1920. The comparison unit 1920 transmits a change value 1922 representing the inclination angle change to an output unit 1930, which processes it to generate and output the control signal 114. According to one exemplary embodiment, the comparison unit 1920 is designed to store the present time of flight 112 as a reference time of flight for a subsequent comparison of a subsequently ascertained time of flight and to use it for the subsequent comparison.

FIG. 20 shows a flow chart of a method according to one exemplary embodiment. The method for controlling a working platform can be executed, for example, by the control device described above on the basis of FIG. 19. In this case, in a step 2010, the time of flight is ascertained using the measurement beam emitted and received again by the distance sensor, in a step 2010, the comparison between the time of flight and the reference time of flight is carried out, and in a step 2030, the control signal for controlling the working platform is generated and output in dependence on a result of the time of flight comparison in step 2020. Steps 2010, 2020, 2030 can be executed continuously.

If an exemplary embodiment comprises an “and/or” linkage between a first feature and a second feature, this is to be read to mean that the exemplary embodiment comprises both the first feature and also the second feature according to one embodiment and comprises either only the first feature or only the second feature according to a further embodiment.

1. A method for controlling a working platform, the working platform comprising at least one distance sensor associated with a wheel of the working platform, the method comprising:
comparing a time of flight of a measurement beam emitted obliquely by the at least one distance sensor onto a track of the working platform and reflected from the track to a reference time of flight to ascertain an inclination angle change of the working platform; and
outputting a control signal to control the working platform in dependence on the inclination angle change.

2. The method as claimed in claim 1, further comprising:
outputting the control signal in order to output a warning message to an operator of the working platform and/or to brake and/or stop the working platform.

3. The method as claimed in claim 1, further comprising:
emitting the measurement beam having a directional component in a travel direction or opposite to the travel direction of the working platform or having a directional component aligned on a trajectory of the working platform.

4. The method as claimed in claim 3, further comprising:
emitting the measurement beam having the directional component set using a steering angle setting of the wheel.

5. The method as claimed in claim 1, further comprising:
ascertaining an inclination angle change representing a descent when the time of flight is greater than the reference time of flight; and/or
ascertaining an inclination angle change representing an ascent when the time of flight is less than the reference time of flight.

6. The method as claimed in claim 1, further comprising:
ascertaining the inclination angle change using a present inclination angle of the working platform and/or a permissible inclination angle of the working platform.

7. The method as claimed in claim 1, further comprising:
ascertaining the inclination angle change using at least one wheel dimension value representing a dimension of the wheel and/or an inclination profile of the track provided by a digital map.

8. The method as claimed in claim 1, wherein:
the working platform further comprises at least one further distance sensor associated with a further wheel of the working platform, and
a further time of flight of a further measurement beam emitted obliquely by the further distance sensor onto the track and reflected from the track is compared to the reference time of flight to ascertain the inclination angle change.

9. The method as claimed in claim 1, wherein:
the working platform further comprises at least one second distance sensor associated with the wheel, and
a second time of flight of a second measurement beam emitted obliquely by the second distance sensor opposite to the measurement beam onto the track and reflected from the track is compared to a second reference time of flight to ascertain a second inclination angle change.

10. A control device, comprising:
a plurality of units configured to execute a method for controlling a working platform,
wherein the working platform includes at least one distance sensor associated with a wheel of the working platform, and
wherein the method includes (i) comparing a time of flight of a measurement beam emitted obliquely by the at least one distance sensor onto a track of the working platform and reflected from the track to a reference time of flight to ascertain an inclination angle change of the working platform, and (ii) outputting a control signal to control the working platform in dependence on the inclination angle change.

11. An inclination angle measuring system for a working platform, comprising:
at least one distance sensor associated with a wheel of the working platform for emitting a measurement beam obliquely to a track of the working platform; and
a control unit including a plurality of units configured to execute a method for controlling the working platform,
wherein the method includes (i) comparing a time of flight of the measurement beam emitted obliquely by the at least one distance sensor onto the track of the working platform and reflected from the track to a reference time of flight to ascertain an inclination angle change of the working platform, and (ii) outputting a control signal to control the working platform in dependence on the inclination angle change.

12. The method as claimed in claim 1, wherein a computer program is configured to execute and/or control the method.

13. The method as claimed in claim 12, wherein the computer program is stored on a machine-readable storage medium.
